(19) United States
(12) Patent Application Publication
(10) Pub. No.: US 2011/0063083 A1
(43) Pub. Date: Mar. 17, 2011

(54) RF TAG READER AND WRITER

(75) Inventor: Kouichi Sano, Shizuoka-ken (JP)

(73) Assignee: TOSHIBA TEC KABUSHIKI KAISHA, Tokyo (JP)

(21) Appl. No.: 12/876,460

(22) Filed: Sep. 7, 2010

(30) Foreign Application Priority Data
Sep. 15, 2009 (JP) 2009-213087

(51) Int. Cl. G06K 7/01; H01Q 3/24; H01Q 1/52

(52) U.S. Cl. 340/10.1; 343/876; 343/841

(57) ABSTRACT

The present invention relates to an RF tag reader and writer including: an antenna device which has a first radiation element and a second radiation element which is larger than the first radiation element, causes the first radiation element to radiate radio waves with an intensity distribution capable of communicating only with RF tags located in a region in the vicinity of the first radiation element, and causes the second radiation element to radiate radio waves with an intensity distribution capable of communicating with RF tags located in a range broader than that of the first radiation element; and an antenna switching control unit configured to select either the first or second radiation element to radiate radio waves and switching therebetween based on a user's operation.

### CROSS-REFERENCE TO RELATED APPLICATION

This application is based upon and claims the benefit of priority from Japanese Patent Application No. 2009-213087, filed on Sep. 15, 2009; the entire contents of which are incorporated herein by reference.

### FIELD

The embodiments described in this specification relate to an RF tag reader and writer for communicating with an RF tag in a non-contact manner and to an antenna thereof.

### BACKGROUND

The RFID (Radio Frequency Identification) system is attracting attention and, for example, is being introduced in the distribution field and the like. The RFID system includes an IC chip and an antenna, and is constituted by an RF tag (also referred to as a wireless tag or an RFID tag) attached to goods and an RF tag reader and writer (hereinafter, also simply referred to as a reader and writer) for reading information stored in a memory within the IC chip of the RF tag in a non-contact manner and writing information in the memory within the IC chip of the RF tag in a non-contact manner.

In regard to processing by the RFID system, a collective information reading process from a plurality of RF tags (hereinafter, referred to as collective reading) in regard to counting inventory in a shop or the like can be exemplified. At this time, the reader and writer radiates radio waves in a range up to several meters, executes communication with unspecified RF tags each of which is attached to each of a plurality of commercial goods, and collectively reads the information stored in the respective RF tags. In addition, in regard to other processing by the RFID system, it is possible to exemplify reading and writing processes with respect to one or a plurality of specific RF tags (hereinafter, both of which are referred to as selective reading and selective writing, respectively, and are together referred to as selective communication). At this time, the reader and writer selectively reads information from specific RF tags and selectively writes information in the RF tags.

Here, there are some cases where selective writing or the like is performed in a circumstance in a shop or the like, in which there are a number of commercial goods with the RF tags attached. In such a circumstance, information may be written in an RF tag different from an RF tag in which a user desires to write the information, as a result of the communication with a nearby RF tag by mistake. Accordingly, depending on the operations, the user was required to use both a reader and writer for collective reading and a reader and writer for selective communication, which has a smaller output of the radio wave transmission and has a narrower range of the directionality than that of the reader and writer for collective reading. In addition, when performing selective communication, the user was required to, for example, keep RF tags which were not the communication targets away from the vicinity of the antenna device of the reader and writer.

### BRIEF DESCRIPTION OF THE DRAWINGS

FIG. 1 is a perspective view of an RF tag reader and writer of a first embodiment.

FIG. 2 is a block diagram illustrating a hardware configuration of the RF tag reader and writer of the first embodiment.

FIG. 3 is a circuit configuration diagram of a wireless unit included in the RF tag reader and writer of the first embodiment.

FIG. 4 is a side view of a composite antenna according to the first embodiment.

FIG. 5 is a plan view illustrating a schematic configuration of a first radiation element according to the first embodiment.

FIG. 6 is a plan view illustrating a schematic configuration of a second radiation element according to the first embodiment.

FIG. 7 is a diagram illustrating a process flow relating to communication with an RF tag in the first embodiment.

FIG. 8 is a diagram illustrating an example of a process designation screen in the first embodiment.

FIG. 9 is a diagram illustrating an example of a result notification screen in the first embodiment.

FIG. 10 is a diagram illustrating an example of a process start screen in the first embodiment.

FIG. 11 is a diagram illustrating an example of a result notification screen in the first embodiment.

FIG. 12 is a diagram illustrating an example of a result notification screen in the first embodiment.

FIG. 13 is a perspective view of an antenna device with a restriction member mounted thereon according to a second embodiment.

### DETAILED DESCRIPTION

### First Embodiment

According to a first embodiment, the RF tag reader and writer includes an antenna device and an antenna switching control unit. The antenna device includes a first radiation element and a second radiation element which is larger than the first radiation element. The antenna device radiates radio waves, which are for communicating only with the RF tags located in a region in the vicinity of the first radiation element, from the first radiation element and radiates radio waves, which are for communicating with the RF tags located in a range which is broader than that of the first radiation element, from the second radiation element. For example, the antenna device radiates radio waves with an intensity distribution, which is capable of communicating only with the RF tags located in the region in the vicinity of the first radiation element, from the first radiation element and radiates radio waves with an intensity distribution, which is capable of communicating with the RF tags located in a range which is broader than that of the first radiation element, from the second radiation element. In addition, in accordance with a user's operation, the antenna switching control unit selects and switches to perform radiation of radio waves by either the first or second radiation elements.

Hereinafter, the description will be made of the embodiments with reference to the drawings. The following description will be made while exemplifying an identification ID as the information to be read from or written in the RF tags. In addition, the description will be made while using collective reading, which is used in operations such as counting inventory and the like, as an example of collective communication.

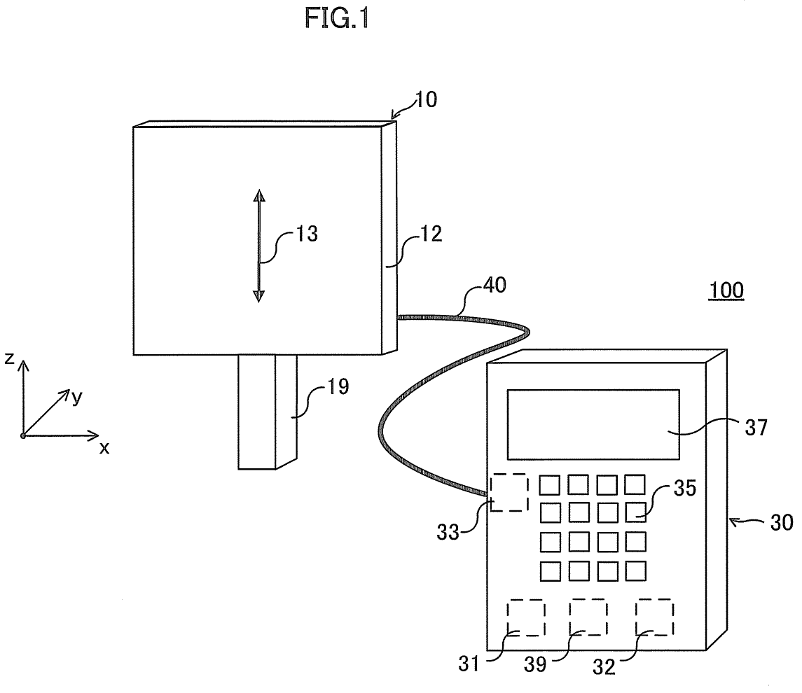

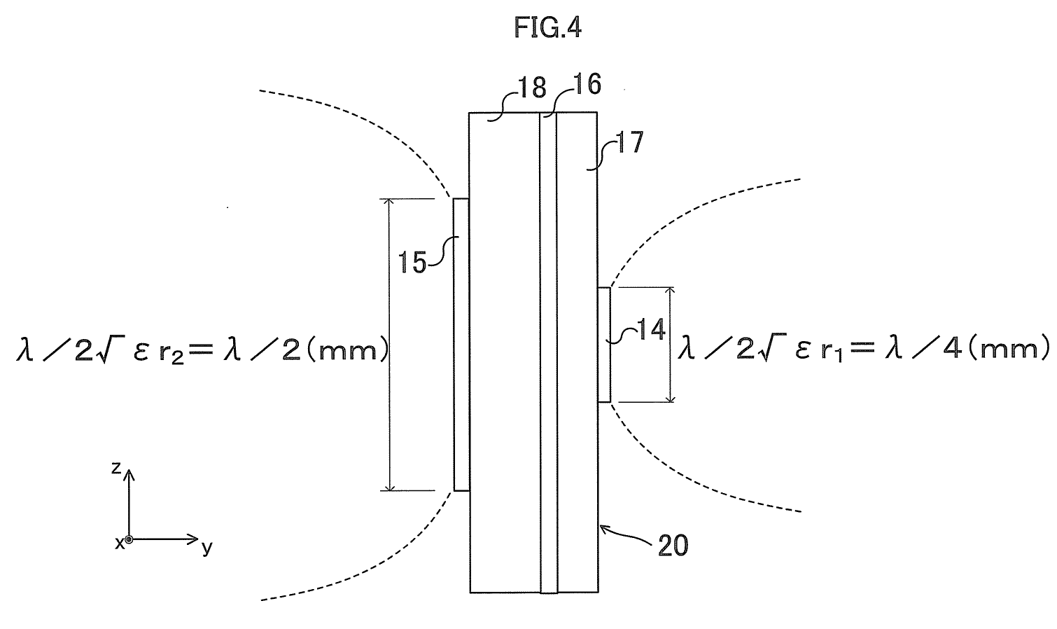

FIG. 1 is a perspective view illustrating a schematic configuration of an RF tag reader and writer 100 according to the first embodiment. The reader and writer 100 of the first embodiment includes an antenna device 10 and a reader and writer main body 30. The antenna device 10 and the reader and writer main body 30 are connected by a coaxial cable 40. The antenna device 10 includes an antenna case body 12 and a composite antenna 20 having a first radiation element 14 and a second radiation element 15 shown in FIGS. 4 to 6, which are accommodated in the case body 12. The reader and writer 100 communicates with RF tags (not illustrated) via radio waves radiated from the composite antenna 20.

In the first embodiment, at this time, the reader and writer 100 can radiate radio waves with an intensity distribution, which is capable of communicating only with the RF tags located in the region in the vicinity of the first radiation element 14, from the first radiation element 14 by adjusting (changing) the transmission output. In addition, the second radiation element 15 can radiate radio waves with an intensity distribution which is capable of communicating with the RF tags located in a range which is broader than that of the first radiation element 14 by adjusting the transmission output.

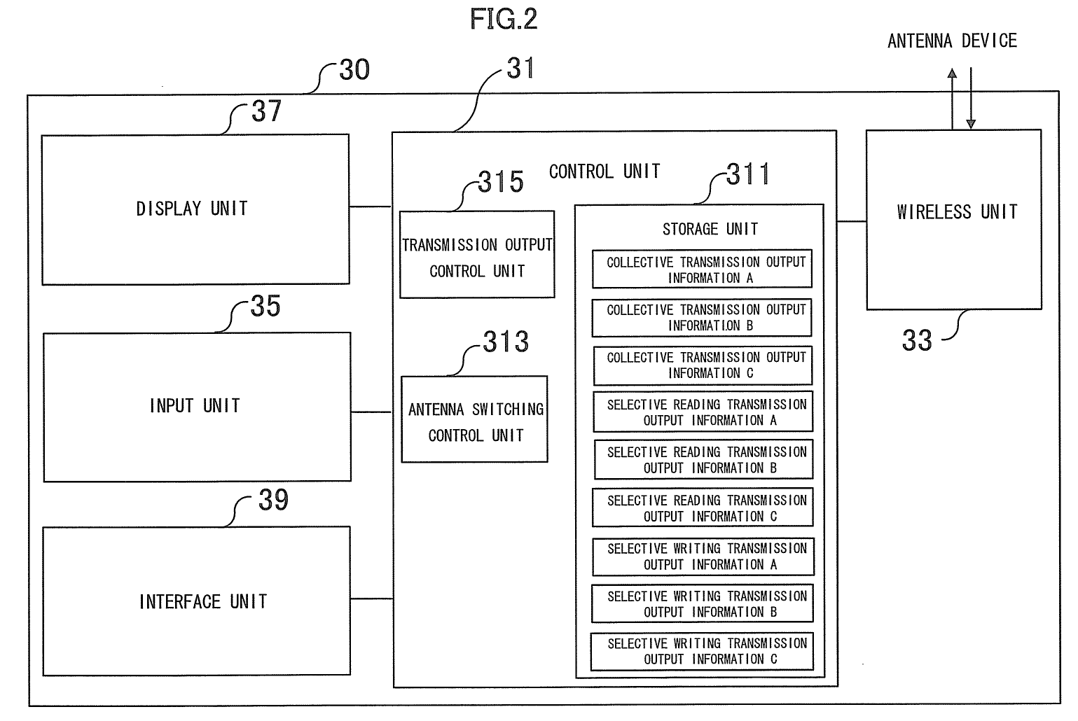

First, the description will be made of a configuration of hardware provided in the reader and writer main body 30. As shown in FIG. 2, the reader and writer main body 30 includes a control unit 31, a wireless unit 33, an input unit 35, a display unit 37, and an interface unit 39. In addition, a power source unit 32, which controls a battery and the charge and discharge thereof, shown in FIG. 1, supplies a current to each hardware unit and the antenna device 10. Accordingly, the reader and writer 100 of the first embodiment is configured as a mobile reader and writer.

The control unit 31 has a function for performing various processes in the reader and writer 100, such as communication with the RF tags or communication with external devices such as a personal computer (not illustrated) and the like via a network, by executing a program stored in a storage unit 311, which will be described later, based on the input from a user. For example, the wireless unit 33 is controlled in accordance with a communication protocol such that an identification ID, which is obtained by a personal computer via the interface unit 39 which will be described later or which is input by the user via the input unit 35 which will be described later, is transmitted from the antenna device 10 to the RF tags via radio waves. In addition, the control unit 31 includes the storage unit 311, an antenna switching control unit 313, and a transmission output control unit 315, which will be described later.

The storage unit 311 stores output information which is information to be used by the transmission output control unit 315, which will be described later, regarding a magnitude of the transmission output corresponding to the type of processing, collective reading, selective reading or selective writing, in addition to the obtained identification ID and the communication protocol for transmitting the identification ID via radio waves (a communication protocol for RF tags complying with ISO18000-6, for example).

The antenna switching control unit 313 switches the radiation element, from which the radio waves are radiated, between the first radiation element 14 and the second radiation element 15 in accordance with a process to be performed (in other words, performing selection of from which radiation element the radio waves are radiated). Specifically, the antenna switching control unit 313 controls the wireless unit 33 so as to cause the second radiation element 15 to radiate radio waves when performing collective reading. In addition, the antenna switching unit 313 controls the wireless unit 33 so as to cause the first radiation element 14 to radiate radio waves when performing selective communication.

The transmission output control unit 315 controls the wireless unit 33, which will be described later, to causes the antenna device 10 to radiate radio waves at a transmission output based on the transmission output information stored in the storage unit 311.

Here, according to the first embodiment, when the transmission output control unit 315 controls the wireless unit 33, which will be described later, based on the output information relating to selective reading and selective writing (the selective reading output information and the selective writing output information), the transmission output control unit 315 causes the antenna device 10 (specifically, the first radiation element 14) to radiate radio waves at a transmission output capable of communicating only with the RF tags positioned in the region in the vicinity of the first radiation element 14. In addition, when controlling the wireless unit 33 based on the collective reading output information relating to collective reading, the transmission output control unit 315 causes the antenna device 10 (specifically, the second radiation element 15) to radiate radio waves at a transmission output greater than that for performing selective reading or selective writing.

Specifically, the control unit 31 of the first embodiment can be configured with a CPU, a RAM, and a ROM mounted on the reader and writer main body 30.

In addition, a suitable value for the transmission output varies depending on the type of the RF tags, and the communication circumstances where the processes are performed (for example, material of walls, material of shelves onto which the RF tags are being mounted, material of goods to which the RF tags are attached, density of the RF tags, and the like) in addition to the process type such as collective reading and selective communication. Accordingly, when the transmission output is preset for the respective processes, it is preferable that plural pieces of output information are stored for one process as in the first embodiment since it is possible to more suitably set the transmission output. When the explanation is made while exemplifying collective reading, three types of output information indicating different transmission outputs of collective reading output information A, B, and C are stored in the first embodiment.

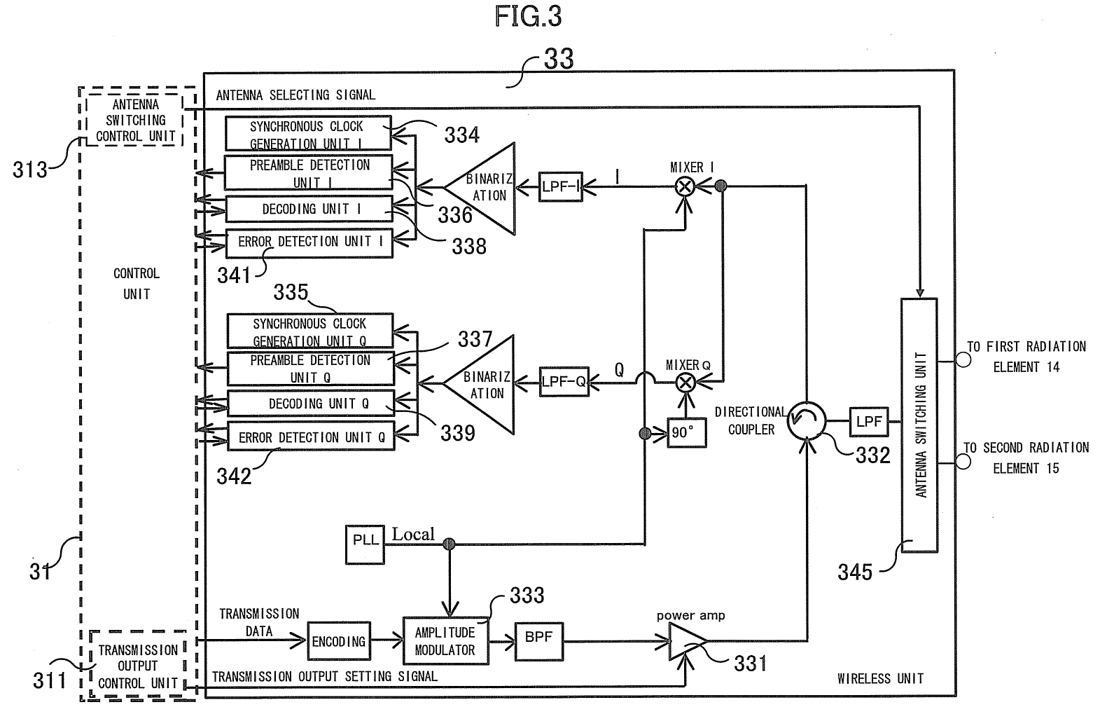

The wireless unit 33 is a hardware unit with a function of communicating with the RF tags via the antenna device 10. FIG. 3 is a detailed circuit configuration diagram of the wireless unit 33.

Here, if the RF tags are passive tags with no battery, the wireless unit 33 first amplifies a non-modulated carrier with a power amplifier 331, outputs electromagnetic waves from the antenna via a directional coupler 332, and activates the RF tags. When transmitting data to the RF tags, the wireless unit subjects the signal encoded in accordance with a communication protocol to an amplitude modulation at an amplitude modulator 333, then amplifies the signal with the power amplifier 331, subsequently outputs electromagnetic waves from the antenna via the directional coupler 332, and thereby transmits the data. In addition, when a signal is received from the RF tags, the RF tags control (back scatter) impedance at the end of the antenna while the reader and writer 100 is transmitting the non-modulated carrier, thereby the reflection state is changed, and the antenna device of the reader and writer 100 detects the change. The directional coupler 332 performs orthogonal demodulation on the received electromagnetic wave signal, and synchronous clock generation units I (334) and Q (335) generate a synchronous clock. Then, preamble detection units I (336) and Q (337) detect a predetermined preamble to thereby detect a head of the data, and decoding units I (338) and Q (339) perform decoding to obtain the received data. In addition, error detection units I (341) and Q (342) are configured to detect the existence of errors using an error detection sign. FIG. 3 shows a configuration in which it is determined that the data is appropriately received if there is no error in either the demodulation of the in-phase component of the orthogonal demodulation or the demodulation of the orthogonal component. In addition, the power amplifier 331 is configured so as to be able to set the transmission output depending on the type of the process based on the control by the transmission output control unit 315 of the control unit 31 (specifically, the transmission of the transmission output setting signal to set the transmission output). In addition, an antenna switching unit 345 sets a radiation element, from which radio waves are radiated, from between the first radiation element 14 and the second radiation element 15 based on the control by the antenna switching control unit 313 of the control unit 31 (specifically, a transmission of an antenna switching signal to switch the antenna).

The input unit 35 is a hardware unit for a user to input instructions to the reader and writer 100, and specifically, can be configured with buttons (keys) capable of inputting instructions by being pressed, a touch pad, and the like.

The display unit 37 is a hardware unit which can be used to show a communication result with the RF tags to the user and to encourage the user to input instructions, and specifically, can be configured by an LCD (Liquid Crystal Display) or the like. In addition, the display unit 37 may be configured as a graphical display with a touch panel sensor mounted thereon, and the input unit 35 and the display unit 37 may be integrated.

The interface unit 39 is a hardware unit for communicating with an external device such as a personal computer, which stores identification IDs, via network.

Next, the description will be made of the antenna device 10 of the first embodiment.

As shown in FIG. 1, the antenna device 10 includes the substantially rectangular antenna case body 12 and the composite antenna 20 which is accommodated in the antenna case body 12. In the first embodiment, the antenna case body 12 is provided with a grip member 19 to make it easy to grip the antenna device 10 when the user uses the reader and writer 100 while carrying it. However, of course, the antenna case body 12 can be configured without the grip member 19.

FIG. 4 is a side view, in a Y-Z plane, of the composite antenna 20 which is accommodated in the antenna case body 12 according to a first embodiment. The composite antenna 20 includes the first radiation element 14, the second radiation element 15, an earth conductor 16, a first dielectric layer 17, and a second dielectric layer 18.

The first radiation element 14 and the second radiation element 15 are plate-shaped radiation elements, each of which has a substantially rectangular shape in a plan view, is constituted by a conductive material such as aluminum, copper or the like, and is disposed substantially parallel to each other. The earth conductor 16 is constituted by a conductive material such as aluminum, copper or the like, and disposed between the first radiation element and the second radiation element. Moreover, the first dielectric layer 17 is disposed between the first radiation element 14 and the earth conductor 16, and the second dielectric layer 18 is disposed between the second radiation element 15 and the earth conductor 16. That is, the composite antenna 20 includes a first patch antenna having the first radiation element 14 and a second patch antenna having the second radiation element 15.

In the first embodiment, it is possible to integrate the first radiation element and the second radiation element and commonly use the earth conductor by configuring the composite antenna 20 provided in the antenna device 10 as mentioned above. Accordingly, it is possible to achieve the reduction in the size and the weight of the antenna device 10 compared to other configurations where two patch antennas are provided.

Here, in the first embodiment, the first dielectric layer 17 has a greater relative permittivity than that of the second dielectric layer 18, and the outer shape of the second radiation element 15 is larger than that of the first radiation element 14. According to the antenna device 10 of the first embodiment with a configuration in which the radiation elements are provided which have outer shapes with different sizes, it is possible to concentrate the radio waves radiated from the antenna device 10 on a closer vicinity as shown by a broken line in FIG. 4 when the radio waves are caused to be radiated from the smaller radiation element. Accordingly, the antenna device 10 can cause the first radiation element 14 to radiate radio waves with an intensity distribution capable of communicating only with the RF tags located in a region in the vicinity of the radiation element 14, based on the control by the reader and writer main body 30. Therefore, the reader and writer 100 of the first embodiment can reliably communicate with specific RF tags in selective communication. In addition, the reader and writer 100 of the first embodiment has the second radiation element 15 which has a larger antenna gain and can radiate radio waves capable of communicating with the RF tags in a broader range based on the control by the reader and writer main body 30. Accordingly, it is possible to perform both selective communication and collective reading.

In addition, in the first embodiment, the relative permittivity of the first and second dielectric layers 17 and 18, and the outer shapes and the sizes of the first and second radiation elements 14 and 15 are not particularly limited, and can be appropriately set by those skilled in the art based on a known method. For example, the description will be made of an example in which the relative permittivity of the first dielectric layer 17 (εr₁) is approximately 4, the relative permittivity of the second dielectric layer 18 (εr₂) is approximately 1, and the first and second radiation elements 14 and 15 have square shapes. Here, when the patch antenna has substantially square radiation elements, a length of a side (electric length) of the patch antenna is generally set to be half of a length of a waveform (corresponding to a half wavelength) based on the wavelength (λ) corresponding to a wireless frequency to be used. The length of one side of the first radiation element 14 is represented by the formula: λ/2√εr₁=λ/4 (mm). On the other hand, the length of one side of the second radiation element 15 is represented by the formula: λ/2√εr₂=λ/2 (mm) which is larger than that of the first radiation element.

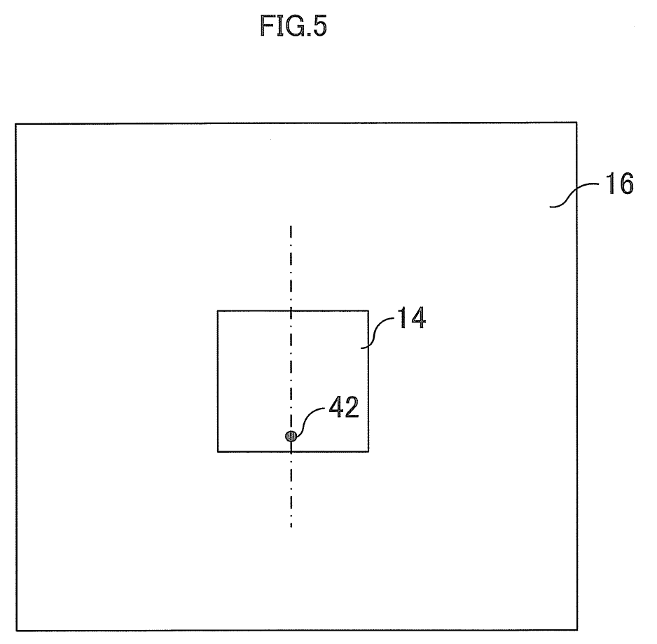

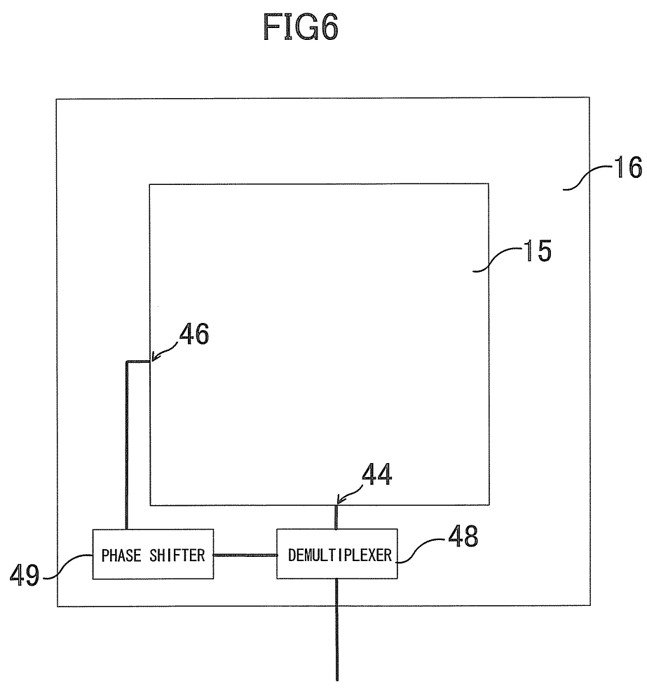

The antenna device 10 of the first embodiment has a configuration in which the first radiation element 14 radiates linear polarization and the second radiation element 15 radiates circular polarization, in addition to a configuration in which the second radiation element 15 has a larger outer shape than that of the first radiation element 14 as described above. Specifically, as shown in FIG. 5, the first radiation element is provided with a feeding point 42 at a position which is different from the central position on a center axis in a plan view for radiating linear polarization. On the other hand, the second radiation element 15 is provided with a demultiplexer 48 and a phase shifter 49 as shown in FIG. 6, and configured to radiate circular polarization in a two-point feeding method using two feeding points 44 and 46 having a phase difference of 90°. In addition, a current from the reader and writer main body 30 is supplied to the feeding points 42, 44, and 46 in FIGS. 5 and 6 via a coaxial cable 40. With such a configuration, the reader and writer 100 of the first embodiment can further reliably communicate with the RF tags with either collective reading or selective communication.

Such operations and effects to be obtained will be described more specifically. Generally, a linear polarization antenna is used for the RF tag antenna. Here, in the case of an operation such as counting inventory or the like, goods are arranged in different directions, and thereby the RF tags are facing to random directions in many cases. Accordingly, when it is assumed that the radio waves to be radiated are linear polarization, communication is not established if the polarization direction of the respective RF tags is perpendicular to the polarization direction of the second radiation element 15. For this reason, it is possible to communicate with more RF tags by allowing the radio waves radiated from the second radiation element 15 to be circular polarization.

On the other hand, when it is assumed that selective communication is to be performed, the RF tag antennas, which are not communication targets, are each facing to random directions in many cases. Accordingly, the communication is not established with the RF tags, which are not communication target and which are facing perpendicularly to the polarization direction of the radio wave, even if the RF tags are located nearby, by the first radiation element 14 radiating linear polarization and the polarization direction of the radio waves matching the polarization direction of the RF tag antenna which is communication target. That is, it is possible to suppress the probability of miscommunication with the RF tag, which is not a communication target, by causing the first radiation element 14 to radiate linear polarization.

For the above reason, in terms of selective communication, it is preferable that a user can easily recognize the polarization direction of the radio waves radiated from the first radiation element 14 for the more reliable selective communication.

Therefore, in the first embodiment, an indicating unit 13 for indicating the polarization direction of the radio waves radiated from the first radiation element 14 is provided in the antenna case body 12 as shown in FIG. 1. With this configuration, the user can easily match the polarization direction of the RF tag antenna to the polarization direction of the radio waves radiated from the first radiation element. Accordingly, it is possible to further reliably perform selective communication with the RF tags which are communication targets.

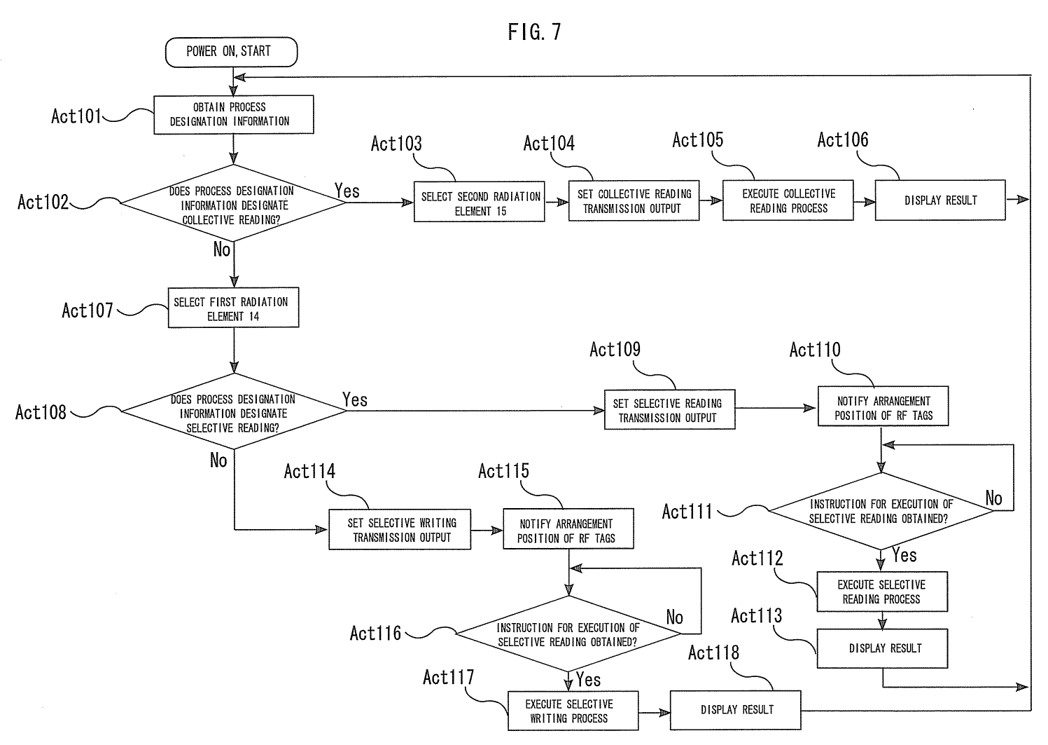

Next, the description will be made of the process flow for the communication with the RF tags relating to collective reading, selective reading, or selective writing by the reader and writer 100 of the first embodiment with reference to FIG. 7. In the following description, the magnitude of the transmission output for the respective processes (that is, which output information is to be based on when the transmission output control unit 315 controls the transmission output for the respective processes) and the number of the RF tags to be communicated with in selective communication are preset in the reader and writer main body 30.

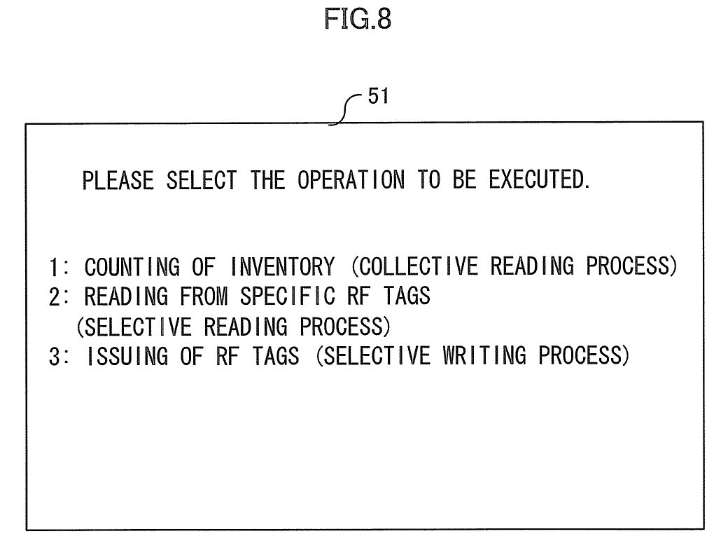

First, in Act 101, the control unit 31 obtains the process designation information indicating which process is to be executed among collective reading, selective reading, and selective writing, based on the input by the user. Specifically, the control unit 31 configures a process designation screen 51 as shown in FIG. 8, and causes the display unit 37 to display the screen. The user designates a desirable process via the input unit 35 based on the process designation screen 51 displayed on the display unit 37. The control unit 31 obtains the process designation information from the user's designation via the input unit 35.

Next, in Act 102, the control unit 31 determines whether the obtained process designation information designates collective reading. If the information designates collective reading, the antenna switching control unit 313 controls the wireless unit 33 to cause the second radiation element 15 to radiate the radio waves (selects the second radiation element 15) in Act 103. Thereafter, in Act 104, the transmission output control unit 315 of the control unit 31 sets the transmission output for the wireless unit 33 based on the collective reading information stored in the storage unit 311.

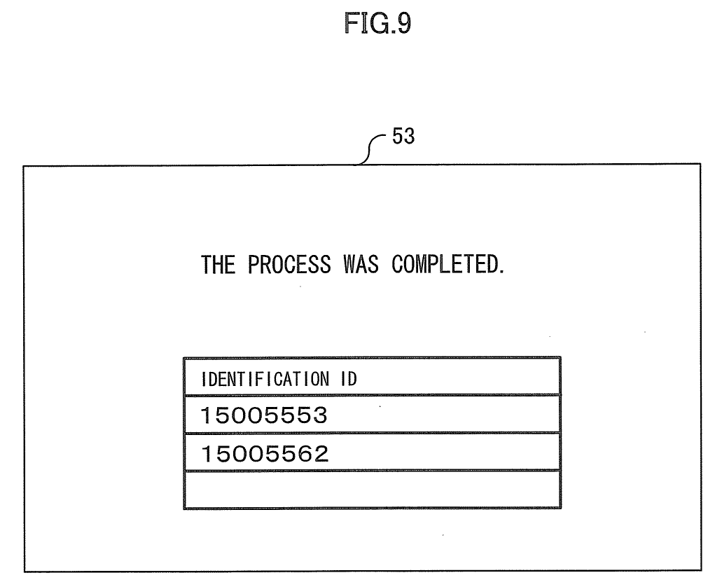

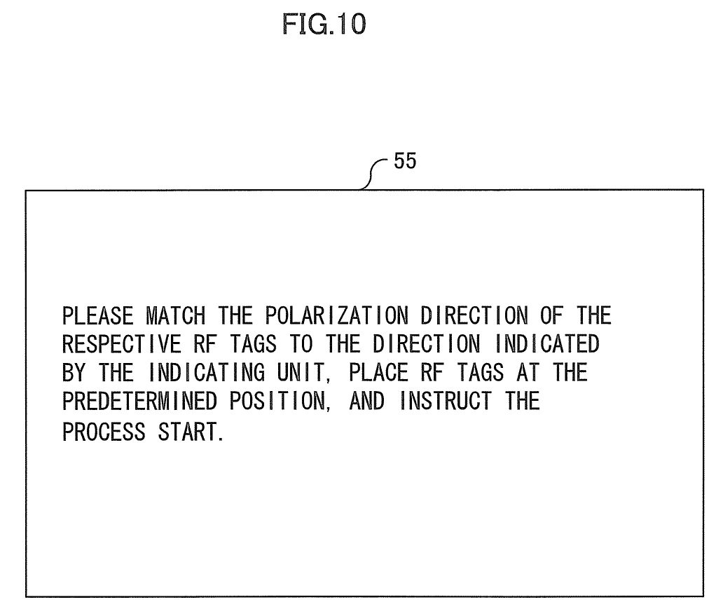

Next, in Act 105, the control unit 31 controls the wireless unit 33 to cause the second radiation element 15 to radiate the radio waves for collective reading, thereby performing collective reading, and obtains the information (identification ID) held in the RF tags. Then, in Act 106, the control unit 31 configures a process result screen 53 (FIG. 9) for informing of the completion of the process and causes the display unit 37 to display the screen, and the process returns to Act 101. If the executed process is collective reading described herein or selective reading, which will be described later, the control unit 31 displays the obtained identification ID along with the notification of the completion of the process on the process result screen and notifies the user. In addition, if the control unit 31 cannot obtain the identification ID, the control unit displays the notification of the failure of the communication with the RF tags instead of the content shown in FIG. 10 on the process result screen 53 and notifies the user.

On the other hand, if it is determined that the process designation information does not designate collective reading in Act 102, the process proceeds to Act 107, and the antenna switching control unit 313 controls the wireless unit 33 to cause the first radiation element 14 to radiate the radio waves (selects the first radiation element 14). Thereafter, in Act 108, the control unit 31 determines whether the process designation information designates selective reading. If the information designates selective reading, the process proceeds to Act 109, and the transmission output setting unit of the control unit 31 sets the transmission output for the wireless unit 33 based on the selective reading output information stored in the storage unit 311.

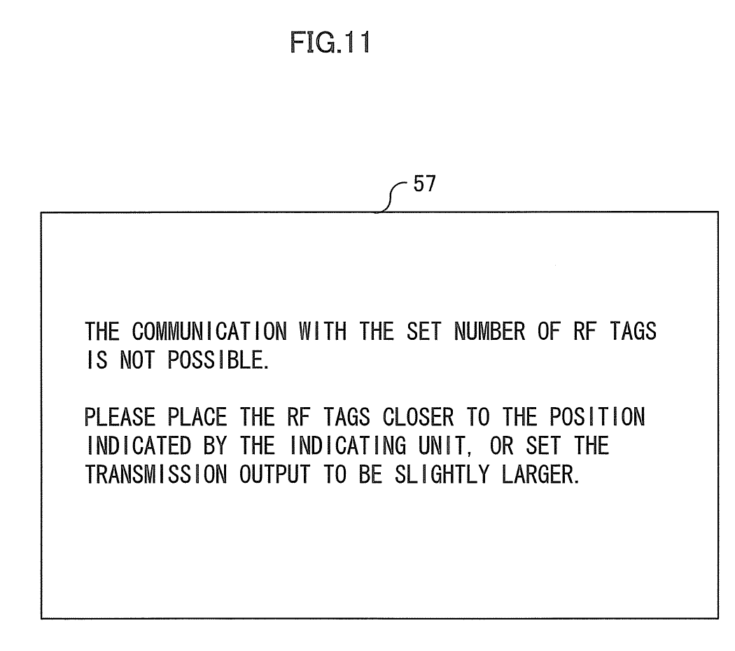

Next, in Act 110, the control unit 31 configures a process start screen 55, as shown in FIG. 11, for encouraging the user to match the polarization direction of the respective RF tags to the polarization direction of the first radiation element 14 and obtaining the user's instruction relating to the start of the reading, and causes the display unit 37 to display the process start screen 55. Then, the process proceeds to Act 111, and the control unit 31 determines whether the information regarding the start of the reading is obtained. If the user matches the polarization direction of the respective RF tags to the polarization direction of the first radiation element 14 in accordance with the indication by the indicating unit 13 and inputs the instruction for the start of the reading via the input unit 35, the control unit 31 obtains the instruction relating to the start of the reading, and the process proceeds to Act 112. In Act 112, the control unit 31 controls the wireless unit 33 to cause the first radiation element 14 to radiate the radio waves for selective reading, performs the selective reading process, and obtains the identification ID held in the respective RF tags. Thereafter, in Act 113, the control unit 31 causes the display unit 37 to display the process result screen 53 for notifying the obtained identification ID along with the notification of completion of the process (FIG. 9), and the process returns to Act 101.

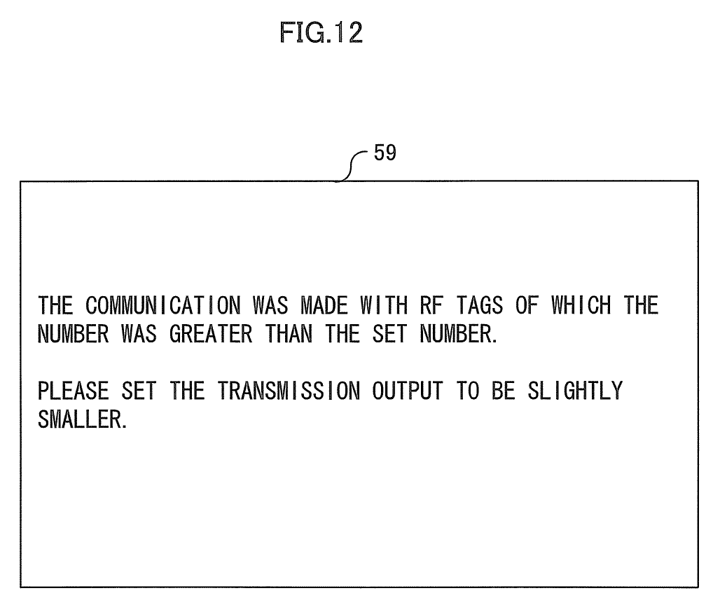

Here, there are cases where the RF tags, of which the number is smaller or larger than that preset by the user, are read as a result of the execution of selective reading. At this time, if the RF tags of which the number is smaller than the set number are read, the control unit 31 configures a process result screen 57 as shown in FIG. 11, causes the display unit 37 to display the screen, and encourages the user to move the RF tags or increase the setting of the transmission output. On the other hand, if the RF tags of which the number is larger than the set number are read, the control unit 31 configures a process result screen 59 as shown in FIG. 12, causes the display unit 37 to display the screen, and encourages the user to decrease the setting of the transmission output.

In Act 108, if it is determined that the process designation information does not designate selective reading, the control unit 31 determines that the process designation information designates selective writing. Then, the process proceeds to Act 114, and the transmission output control unit 315 of the control unit 31 sets the transmission output for the wireless unit 33 based on the selective reading output information stored in the storage unit 311.

Next, in Act 115, the control unit 31 configures the process start screen 55 as shown in FIG. 11 for encouraging the user to match the polarization direction of the respective RF tags to the polarization direction of the first radiation element 14 and obtaining the user's instruction regarding the start of the reading, and causes the display unit 37 to display the screen. Subsequently, the process proceeds to Act 116, and the control unit 31 determines whether or not the instruction for the start of the reading is obtained. If the user matches the polarization direction of the respective RF tags to the polarization direction of the first radiation element 14 in accordance with the indication by the indicating unit 13, and inputs the reading start instruction via the input unit 35, the control unit 31 obtains the instruction for the start of the reading, and the process proceeds to Act 117. In Act 117, the control unit 31 controls the wireless unit 33 to cause the antenna device 10 to radiate the radio waves for selective writing, performs selective writing, and gives the identification ID for the respective RF tags. Then, the control unit 31 confirms that the writing was completed based on the responses from the RF tags, configures the process result screen 53 in the same manner as in the case of reading process, and causes the display unit 37 to display the screen.

Here, there are cases where the writing is performed on the RF tags, of which the number is smaller or larger than that preset by the user in the designation of the process designation information, as a result of the execution of selective writing. At this time, if the writing is performed on the RF tags of which the number is smaller than the preset number, the control unit 31 configures the process result screen 57 as shown in FIG. 11, causes the display unit 37 to display the screen, and encourages the user to move the RF tags or increase the setting of the transmission output. On the other hand, if the writing is performed on the RF tags of which the number is larger than the preset number, the control unit 31 configures the process result screen 59 as shown in FIG. 12, causes the display unit 37 to display the screen, and encourages the user to decrease the setting of the transmission output.

As described above, the user can perform both collective reading and selective communication by the reader and writer 100 of the first embodiment provided with the first radiation element 14 and the second radiation element 15 which is larger than the first radiation element 14. In addition, it is possible to cause the first radiation element to radiate radio waves with an intensity distribution capable of communicating only with the RF tags located in the region in the vicinity of the first radiation element. Accordingly, it is possible to more reliably communicate with specific RF tags in selective communication.

### Second Embodiment

In the first embodiment, the first radiation element 14 and the second radiation element 15 are configured as radiation elements of the patch antenna. In the second embodiment, the first radiation element 14 can be a radiation element of a chip antenna, which is smaller than the radiation element described in the first embodiment, and the second radiation element 15 can be a radiation element of the patch antenna. At this time, the first radiation element 14 and the second radiation element 15 can be accommodated in the same antenna case body, or can be accommodated in different case bodies. In addition, if the first radiation element and the second radiation element are accommodated in the same antenna case body, the first and second radiation elements may be arranged to be substantially parallel to each other. Alternatively, the first and the second radiation elements may be arranged, for example, on an identical plane.

Those skilled in the art can appropriately apply a known configuration to the chip antenna provided in the antenna device according to the second embodiment. However, the chip antenna generally has a cuboid shape with a side of several cm to several mm. That is, it is possible to extremely reduce the physical size of the radiation element as compared with the case where the first radiation element 14 is configured as a patch antenna. Accordingly, by adjusting the transmission output, it is possible to further reduce the range of the radio waves with a radio wave intensity capable of communicating with the RF tags. Therefore, it is possible to provide a more reliable selective communication with the RF tags which are communication targets.

### Third Embodiment

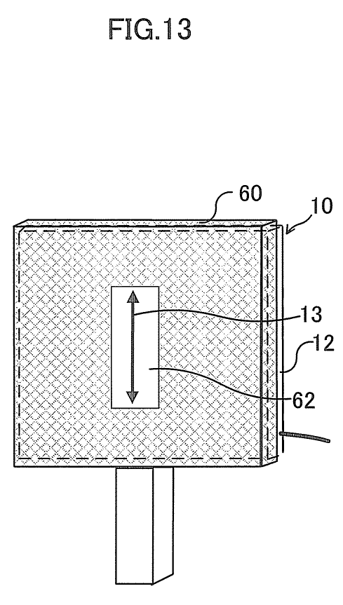

In the third embodiment, the reader and writer 100 further includes a restriction member 60 to be used by being mounted on the antenna device 10 as shown in FIG. 13 in addition to the configuration described in the first embodiment. It is possible to restrict the radiation of the radio waves from the region other than a predetermined region in the antenna case body 12 to the outside of the case body as compared with the radiation of the radio waves from the predetermined region to the outside of the case body, by mounting the restriction member 60 onto the antenna device 10. The restriction member 60 is configured of a metal material, for example, as shown in FIG. 13, and can be a compact provided with an opening portion 62 at a position corresponding to the vicinity of the indicating unit 13. In addition, it is also possible to configure the restriction member 60 in a different form. For example, the restriction member 60 can be a compact which has a surface facing the outer surface of the antenna case body in the mounted state and configured with plastic processed for radio wave absorption (attached with a radio wave absorption material, for example) as its material, and is provided with an opening portion only at a position corresponding to the vicinity of the position indicated by the indicating unit 13 or constituted by an unprocessed plastic.

In the third embodiment, the restriction member 60 is configured to be able to retreat from the position where the radiation of the radio waves from the region other than the predetermined region to the outside of the case body is restricted to the position where the radiation of the radio waves is not restricted, by being detached from the outer surface of the antenna case body 12. However, the retreat of the restriction member 60 from the antenna device 10 is not limited to being detached from the outer surface of the antenna case body, and can be configured in a different form. For example, it is also applicable to configure the restriction member 60 to be connected to the antenna case body 12 via a hinge and allow the restriction member 60 to be movable from a position where the radiation of the radio waves is restricted to a position where the radiation of the radio waves is not restricted (in this specification, “retreat” as a concept includes movement of position).

### Other Embodiments

Although the description was made of the first to third embodiments as above, the invention is not limited thereto and can be applied to other embodiments.

For example, in the first embodiment, the second radiation element 15 of the antenna device 10 is configured such that the two-point feeding method is employed to cause circular polarization to be radiated. However, the second radiation element 15 is not limited thereto, and can be configured in a different form so as to radiate circular polarization. For example, the second radiation element 15 can be formed to have a shape in which two corners on a diagonal line in the rectangular shape are notched point-symmetrically so as to cause circular polarization to be radiated.

Moreover, the output information for controlling the transmission output is stored in the storage unit 311 constituted by the ROM or the RAM in the reader and writer main body 30 in the first embodiment. However, the invention is not limited thereto, and it is also applicable that the output information is stored in a storage unit in the external device and obtained by the control unit 31 via the interface unit 39, if necessary.

Furthermore, although the antenna device 10 (antenna case body 12) and the reader and writer main body 30 are separately configured in the first embodiment, it is also applicable to integrally configure the antenna device 10 and the reader and writer main body 30 by connecting the two case bodies (the antenna case body 12 and the case body of the reader and writer main body 30) or by accommodating the patch antenna and the hardware of the reader and writer main body 30 in respective compartments inside a single case body.

Moreover, although the transmission output is set based on the output information stored in advance in the first embodiment, it is also applicable that the user sets the transmission output via the input unit 35.

Furthermore, in the first embodiment, the control unit 31 switches the antenna to radiate the radio waves based on the input regarding the user's process designation. However, it is needless to say that switching of the antenna to radiate the radio waves can be configured in a different form. For example, the reader and writer main body 30 may be provided with a switching switch for switching the feeding to the first radiation element 14 or the second radiation element using a circuit.

As described above, according to the technique disclosed in this specification, it is possible to collectively communicate with one or a plurality of unspecified RF tags, and reliably communicate with one or a plurality of specific RF tags in selective communication.

While certain embodiments have been described, these embodiments have been presented by way of example only, and are not intended to limit the scope of invention. Indeed, the novel apparatus, methods and computer readable media described herein may be embodied in a variety of other forms; furthermore, various omissions, substitutions and changes in the form of the apparatus and methods and computer readable media described herein may be made without departing from the spirit of the inventions. The accompanying claims and their equivalents are intended to cover such forms or modifications as would fall within the scope and spirit of the inventions.

What is claimed is:

1. An RF tag reader and writer comprising:
an antenna device which has a first radiation element and a second radiation element which is larger than the first radiation element, causes the first radiation element to radiate radio waves for communicating only with RF tags located in a region in the vicinity of the first radiation element, and causes the second radiation element to radiate radio waves for communicating with RF tags located in a range broader than that of the first radiation element; and
an antenna switching control unit configured to select either the first or second radiation element to radiate radio waves and switching therebetween based on a user's operation.

2. The RF tag reader and writer according to claim 1,
wherein the first radiation element radiates linear polarization, and the second radiation element radiates circular polarization.

3. The RF tag reader and writer according to claim 2, further comprising:
an indicating unit configured to indicate a polarization direction of the respective radio waves radiated from the first radiation element.

4. The RF tag reader and writer according to claim 1,
wherein the second radiation element is a plate-shaped radiation element of a patch antenna.

5. The RF tag reader and writer according to claim 1,
wherein the second radiation element is a radiation element of a chip antenna.

6. The RF tag reader and writer according to claim 1,
wherein the first and second radiation elements of the antenna device are plate-shaped radiation elements of patch antennas,
wherein the first and second radiation elements are arranged so as to be substantially parallel to each other, and
wherein the antenna device further includes:
an earth conductor disposed between the first and second radiation elements;
a first dielectric layer disposed between the first radiation element and the earth conductor; and
a second dielectric layer which is disposed between the second radiation element and the earth conductor and has a greater permittivity than that of the first dielectric layer.

7. The RF tag reader and writer according to claim 1, further comprising:
a transmission output control unit configured to control a transmission output of the radio waves radiated from the radiation elements,
wherein the transmission output control unit controls such that the transmission output of the radio waves radiated from the first radiation element is greater than the transmission output of the radio waves radiated from the second radiation element.

8. The RF tag reader and writer according to claim 1, further comprising:
an antenna case body for accommodating at least the first radiation element; and
a restriction member which restricts radiation of radio waves from the vicinity of the first radiation element to the outside of the antenna case body via a region other than a part of region in the antenna case body as compared with radiation of radio waves from the vicinity of the first radiation element to the outside of the antenna case body via the part of region in the antenna case body, and retreats from a position in which the radiation of the radio waves is restricted to the position in which the radiation of the radio waves is not restricted.
